(19) United States
(12) Patent Application Publication
(10) Pub. No.: US 2009/0133491 A1
(43) Pub. Date: May 28, 2009

(54) CAPACITIVE LEVEL SENSOR AND MEASURING APPARATUS USING THE SAME

(76) Inventor: Kyung Min Lee, Ansan-city (KR)

Correspondence Address: MORGAN, LEWIS & BOCKIUS LLP (SF), One Market, Spear Street Tower, Suite 2800, San Francisco, CA, 94105, US

(21) Appl. No.: 11/965,635

(22) Filed: Dec. 27, 2007

(30) Foreign Application Priority Data
Nov. 28, 2007 (KR) 10-2007-0122109

(51) Int. Cl. G01F 23/26

(52) U.S. Cl. 73/304 C

(57) ABSTRACT

A sensor includes two capacitors, with distances between the capacitor plates being different in the two capacitors. An electrical insulator is provided between the capacitors. The distance between the plates of one capacitor may be sufficiently large to prevent capillary action in the capacitor when an end of the first capacitor is placed in a fluid. The distance between the plates of the other capacitor may be sufficiently small to allow capillary action in the capacitor. The first capacitor measures the level of the fluid. The second capacitor measures the viscosity of the fluid. A third capacitor, completely submerged in the fluid, measures the dielectric constant of the fluid. Also, a measuring apparatus using the sensor.

### CROSS-REFERENCE TO RELATED APPLICATION

This application claims priority to, and the benefit of Korean Patent Application No. 10-2007-0122109 filed in the Korean Intellectual Property Office on Nov. 28, 2007, the entire contents of which are incorporated herein by reference.

### BACKGROUND OF THE INVENTION

(a) Field of the Invention

The present invention relates to a capacitive level sensor and a measuring apparatus using the same.

(b) Description of the Related Art

Capacitance level sensors are widely used in the automobile and aircraft industries to measure levels of engine oil or fuel. Such sensors can detect the level by measuring changes in capacitance, which varies with the level as shown by equation 1:

$$C = \frac{ɛ \cdot S}{d} \qquad ( Equation 1 )$$

where S denotes the area of a conductor plate, d denotes the distance between two facing conductor plates, and e denotes the dielectric constant of the material between the plates. If a fluid with a large dielectric constant exists between the conductor plates, capacitance increases when the height of the fluid between the plates increases. The relative dielectric constant of air is 1, while the relative dielectric constant of the oil and fuel is 2.

If pure oil and fuel is mixed with a material, such as water or alcohol, having a different dielectric constant, the capacitance increases due to an increase in dielectric constant.

The relative dielectric constants of ethanol and methanol are respectively 24 and 31, and the relative dielectric constant of water is 78. Therefore, if even a small amount of ethanol, methanol, or water is mixed with the oil or fuel whose level is being measured, the measurement will be inaccurate.

Some capacitance level sensors are known that can measure the contents of the foreign materials with different dielectric constants, but cannot detect when fuel having the same dielectric constant is mixed with the oil. For example, in a vehicle that has a diesel particulate filter (DPF), oil is diluted with fuel, which causes lubrication performance to be deteriorated due to a change in viscosity.

The above information disclosed in this Background section is only for enhancement of understanding of the background of the invention and therefore it may contain information that does not form the prior art that is already known in this country to a person of ordinary skill in the art.

### SUMMARY OF THE INVENTION

A sensor includes two capacitors, with distances between the capacitor plates being different in the two capacitors. An electrical insulator is provided between the capacitors.

The distance between the plates of one capacitor may be sufficiently large to prevent capillary action in the capacitor when an end of the first capacitor is placed in a fluid. The distance between the plates of the other capacitor may be sufficiently small to allow capillary action in the capacitor.

The ends of the capacitors may be open, and the sides may be sealed. The capacitors may be planar or cylindrical.

An apparatus includes a switch that determines an output voltage by selecting a first movable contact or a second movable contact. The switch has a fixed contact to which a first capacitor is connected. A comparison amplifier has a non-inverting terminal to which an output voltage terminal of another comparison amplifier and the second movable contact of the switch are connected, and an inverting terminal to which a second capacitor is connected. The other comparison amplifier has an inverting terminal connected to the first movable contact of the switch and a non-inverting terminal to which a power supply and a third capacitor are connected in parallel. The capacitors measure capacitance of a fluid.

The first capacitor may have a capacitance corresponding to the level of the fluid. The second capacitor may have a capacitance corresponding to the viscosity of the fluid. The third capacitor may have a capacitance corresponding to the dielectric constant of the fluid.

The power supply may be an AC power supply that generates a sine wave. The first and second capacitors may be partially submerged in the fluid, and the third capacitor may be completely submerged in the fluid.

### BRIEF DESCRIPTION OF THE DRAWINGS

FIG. 1 is a cross-sectional view of a planar fluid level sensor according to an exemplary embodiment of the present invention.

FIG. 2 is a cross-sectional view of a cylindrical fluid level sensor according to an exemplary embodiment of the present invention.

FIG. 3 is a cross-sectional view of a fluid level sensor according to an exemplary embodiment of the present invention installed in a fluid tank.

FIG. 4 is a circuit diagram of a measuring apparatus according to an exemplary embodiment of the present invention.

### DETAILED DESCRIPTION OF PREFERRED EMBODIMENTS

In the following detailed description, only certain exemplary embodiments are shown and described, simply for purposes of illustration. As those skilled in the art will realize, the described embodiments may be modified in various different ways, all without departing from the spirit or scope of the present invention. Accordingly, the drawings and description are to be regarded as illustrative in nature and not restrictive.

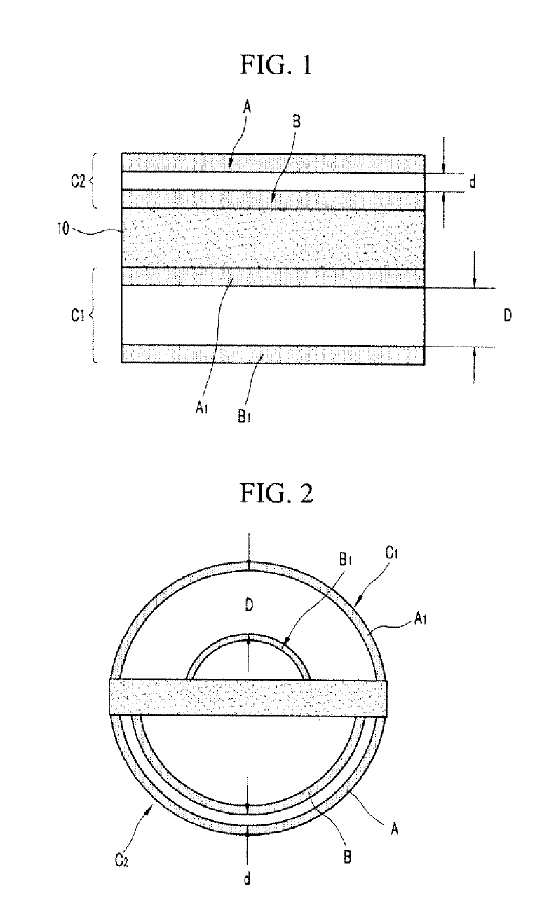

As shown in FIGS. 1 and 2, first and second capacitors C1 and C2 each includes two conductor plates A and B. An electrical insulator 10 is provided between the first capacitor C1 and the second capacitor C2.

The distance D between the conductor plates A₁ and B₁ of the first capacitor C1 is selected to prevent the level of the fluid from increasing due to capillary action between the conductor plates A₁ and B₁. The distance d between the conductor plates A and B of the second capacitor C2, is extremely small, such that the level of the fluid does increased due to capillary action between the conductor plates A and B.

Both ends of the first and second capacitors C1 and C2 in a longitudinal direction (the left and right ends in FIG. 1, the ends into and out of the page in FIG. 2) are open to enable the inflow and outflow of the fluid or air, and the sides thereof (the sides into and out of the page in FIG. 1, the circumferential surface in FIG. 2) are sealed.

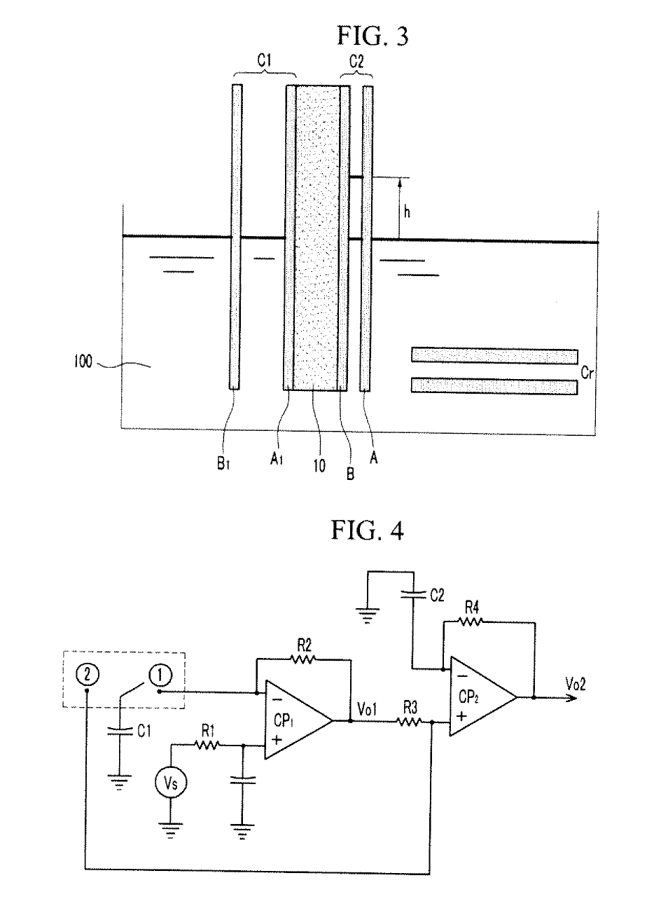

As shown in FIG. 3, a third, reference capacitor Cr is separately installed near the bottom of a fluid tank 100 such that the third capacitor Cr is always completely submerged in the fluid. The third capacitor Cr detects changes in the dielectric constant of the fluid, such as changes due to the introduction of foreign materials or changes in temperature.

In addition, the above-described capacitive level sensor is installed such that one of its open ends is near the bottom surface of the fluid tank 100.

In the first capacitor C1, the level of the fluid between the conductor plates A₁ and B₁ is maintained at the same level as the external fluid, as shown in the drawing. However, in the second capacitor C2, the level of the fluid between the conductor plates A and B rises to a height h above the external fluid level. The same is true of the cylindrical level sensor of FIG. 2.

In order to increase the height h, a barrier wall may be provided between the conductor plates A and B in a longitudinal direction.

Turning now to FIG. 4, the first capacitor C1 is connected to a fixed contact of a switch that selects an output voltage by selecting either a first movable contact \textcircled{1} or a second movable contact \textcircled{2}.

The first movable contact \textcircled{1} of the switch S/W is connected to an inverting terminal (−) of a first comparison amplifier CP1, and the second movable contact \textcircled{2} is connected to a non-inverting terminal (|) of a second comparison amplifier CP2.

A power supply Vs and the third capacitor Cr are connected in parallel to the non-inverting terminal + of the first comparison amplifier CP1.

An output voltage terminal Vo1 of the first comparator amplifier CP1 is connected to the non-inverting terminal (+) of the second comparison amplifier CP2 through a resistor R3.

The second capacitor C2 is connected to the inverting terminal (−) of the second comparison amplifier CP2.

The power supply Vs may be an AC power supply that generates a sine wave having a predetermined frequency.

The first capacitor C1 has a capacitance that corresponds to the level of the fluid.

The first capacitor C1 serves to convert an output voltage by changing a circuit structure according to the selection of the contacts from the switch.

The second capacitor C2 has a capacitance that corresponds to the viscosity of the fluid.

The third capacitor Cr has a capacitance that corresponds to the dielectric constant of the fluid in the tank 100, or “reference” capacitance.

An engine control device (not shown) controls the operation of the switch S/W and an operation for converting the output voltages Vo1 and Vo2 according to the selection of the contacts from the switch S/W into the variation in dielectric constant of the fluid, the variation in level of the fluid, and the variation in viscosity of the fluid. The engine control device many include a processor, memory, and associated hardware, software, and/or firmware as may be selected and programmed by a person of ordinary skill in the art based on the teachings herein.

The operation of the measuring apparatus that has the above-described structure will now be described.

Capacitance of each capacitor is defined by Equation 1:

$$C = \frac{ɛ \cdot S}{d} \qquad ( Equation 1 )$$

where S denotes the area of a conductor plate, d denotes the distance between two facing conductor plates, and ε denotes the dielectric constant of the material between the plates.

Since the fluid coexists with air, the dielectric constant changes in response to the level of the fluid. However, since the third capacitor Cr having the reference capacitance is constantly filled with the fluid, regardless of the level of the fluid, the changes in dielectric constant, such as due to the introduction of foreign materials having different dielectric constants, or changes in temperature, are reflected in the capacitance of the third capacitor Cr.

Since the dielectric constants of fuel and oil are each twice than that of the air, the dielectric constant between the conductor plates A and B, and A₁ and B₁, changes according to the level of the fluid in each capacitor C₁, C₂.

The height of the liquid surface between the conductor plates A and B of capacitor C₂ is represented by Equation 2:

$$h = \frac{T cos Θ}{d ρ g} \qquad ( Equation 2 )$$

where d denotes the distance between the conductor plates A and B, ρ denotes the fluid density, g denotes acceleration due to gravity, T denotes the surface tension of the fluid, and θ denotes a tangential angle of the concave surface of the fluid.

The surface tension of the fluid varies with viscosity, and therefore varies with contamination of foreign material.

Therefore, if a viscous fluid, such as oil, is diluted with a less viscous fluid, such as fuel, even if the dielectric constants are similar (as is the ease with oil and fuel), the contamination can be detected on the basis of capacitance varying in response to a change in viscosity.

The structure of the circuit changes according to which contact, \textcircled{1} or \textcircled{2}, is selected by the switch. As a result, the output voltages Vo1 and Vo2 are changed and physical quantities by the output voltages are also changed.

First, when the switch S/W selects the second movable contact \textcircled{2}, the first comparison amplifier CP1 functions as a non-inverting buffer, and the output voltage Vo1 is determined by the output voltage of the third capacitor Cr. Therefore, the output voltage Vo1 is represented by Equation 3:

$${V}_{o 1} = \frac{1}{1 + jω {R}_{1} {C}_{r}} {V}_{s} \qquad ( Equation 3 )$$

where j is \sqrt{−1}, and ω is the frequency of the A/C voltage Vₛ.

In the case where the switch S/W selects the second movable contact \vec{2}, when a material having a different dielectric constant is introduced into the fluid (for example, coolant or failed fuel containing water inflows into an engine oil), the output voltage of the third capacitor Cr changes, changing the output voltage Vo1 of the first comparison amplifier CP1.

In addition, in the case where the switch S/W selects the second movable contact \vec{2}, the output voltage Vo2 of the second comparison amplifier CP2 is determined by the output voltage Vo1 of the first comparison amplifier CP1 and the output voltage of the second capacitor C2, whose capacitance varies with viscosity, as represented by Equation 4.

Therefore, since the output voltage Vo2 of the second comparison amplifier CP2 is determined by a ratio of the “level” capacitance of the first capacitor C1 and the “viscosity” capacitance of the second capacitor C2, the output voltage Vo2 may depend on only the change in viscosity regardless of the level of the fluid or the introduction of foreign material with a different dielectric constant.

$${V}_{o 2} = \frac{1 + jω {R}_{4} {C}_{2}}{1 + jω {R}_{3} {C}_{1}} {V}_{01} \qquad ( Equation 4 )$$

In the case where the switch selects the first movable contact \vec{1}, a ratio of the output voltage Vo1 of the first comparison amplifier CP1 to the power supply voltage Vs is determined by a ratio of the “level” capacitance of the first capacitor C1 to the “reference” capacitance of the third capacitor Cr, as represented by Equation 5, detecting the fluid level.

$${V}_{o 1} = \frac{1 + jω {R}_{2} {C}_{1}}{1 + jω {R}_{1} {C}_{r}} Vs \qquad ( Equation 5 )$$

As represented by Equation 5, since the ratio of the output voltage Vo1 of the first comparison amplifier CP1 to the power supply voltage Vs is determined by a ratio of the level capacitance of the first capacitor C1 to the reference capacitance of the third capacitor Cr, the level of the fluid can be accurately measured even if a foreign material having a different dielectric constant is introduced.

In the case where the switch S/W selects the first movable contact \vec{1}, the output voltage Vo2 of the second comparison amplifier CP2 is determined by the output voltage Vo1 of the first comparison amplifier CP1 and the output voltage of the second capacitor C2 having the “viscosity” capacitance, as represented by Equation 6.

Vₒ₂=(1+jωR₄C₂)Vₒ₁ (Equation 6)

Therefore, the output voltage Vo1 of the first comparison amplifier CP1 and the output voltage Vo2 of the second comparison amplifier CP2 are compared to detect a change in the output voltage of the second capacitor CP2, having the “viscosity” capacitance, thereby detecting changes in viscosity.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A sensor, comprising:
a first capacitor comprising two facing plates with a first distance between the plates;
a second capacitor comprising two facing plates with a second, different distance between the plates; and
an electrical insulator between the first and second capacitors.

2. The sensor of claim 1, wherein ends of the capacitors are open, and sides of the capacitors are sealed.

3. The sensor of claim 1, wherein the first distance is sufficiently large to prevent capillary action in the first capacitor when an end of the first capacitor is placed in a fluid, and the second distance is sufficiently small to allow capillary action in the second capacitor when an end of the second capacitor is placed in the fluid.

4. The sensor of claim 1, wherein the capacitors are substantially planar.

5. The sensor of claim 1, wherein the capacitors are substantially cylindrical.

6. An apparatus, comprising:
a switch that determines an output voltage by selecting a first movable contact or a second movable contact, and comprises a fixed contact to which a first capacitor is connected;
a first comparison amplifier; and
a second comparison amplifier:
wherein the second comparison amplifier comprises a non-inverting terminal to which an output voltage terminal of the first comparison amplifier and the second movable contact of the switch are connected, and an inverting terminal to which a second capacitor is connected;
wherein the first comparison amplifier comprises an inverting terminal connected to the first movable contact of the switch and a non-inverting terminal to which a power supply and a third capacitor are connected in parallel;
and wherein the capacitors measure capacitance of a fluid.

7. The apparatus of claim 6, wherein the power supply comprises an AC power supply that generates a sine wave.

8. The apparatus of claim 6, wherein the first capacitor comprises a level capacitance corresponding to a level of the fluid, the second capacitor comprises a viscosity capacitance corresponding to a viscosity of the fluid, and the third capacitor comprises a reference capacitance corresponding to a dielectric constant of the fluid.

9. The measuring apparatus of claim 6, wherein:
the first and second capacitors are partially submerged in the fluid, and the third capacitor is completely submerged in the fluid.
